(19) United States
(12) Patent Application Publication
(10) Pub. No.: US 2012/0099629 A1
(43) Pub. Date: Apr. 26, 2012

(54) Communications Wiring Noise Level Monitor and Alarm Indicator

(75) Inventors: Roger Faulkner, South Marston (GB); Gregory M. Nulty, Reston, VA (US)

(73) Assignee: TOLLGRADE COMMUNICATIONS, INC, Cranberry Township, PA (US)

(21) Appl. No.: 13/279,382

(22) Filed: Oct. 24, 2011

Related U.S. Application Data
(60) Provisional application No. 61/405,846, filed on Oct. 22, 2010.

(51) Int. Cl. H04B 1/38

(52) U.S. Cl. 375/222

(57) ABSTRACT

In an apparatus and method of testing the capacity of a network to support DSL services, a test device is coupled to a pair of wires (e.g., Tip-Ring) that support DSL services between ATU-C and ATU-R modems. In operation, the test device: samples for a DC line feed or potential on the wires when the ATU-R and ATU-C modems are operatively connected via the wires; samples for AC noise present on the wires when the ATU-R modem is electrically isolated from the ATU-C modem which is operatively coupled to the wires; samples for DSL signals output by the ATU-R modem when the ATU-C modem is electrically isolated from the ATU-R modem; and samples for DSL signals on the wires when the ATU-R modem is operatively coupled to the ATU-C modem via the wires. Based on these samples, the test device determines the capacity of the network to support DSL services.

### CROSS REFERENCE TO RELATED APPLICATION

This application claims priority from U.S. Provisional Patent Application No. 61/405,846, filed Oct. 22, 2010, which is incorporated herein by reference.

### BACKGROUND OF THE INVENTION

1. Field of the Invention

The present invention relates to test and measurement of one or more pairs of conductors used to deliver telephony, internet, and video services over digital subscriber lines (DSL).

2. Description of Related Art

Impairments in pairs of conductors, e.g., Tip-Ring pairs, utilized to deliver telephony, internet and video services over digital subscriber lines (DSL) within or close to a residence or other structure can render broadband service unreliable for internet access and/or for internet based services such as IPTV or VoIP. It has been observed that much of the inside wiring problems reduce down to abnormally high levels of differential noise compared to the signal levels received at an ATU-R modem (the customer's DSL modem employed in the residence or structure) that were sent by an ATU-C modem (the DSL service provider's DSL modem deployed outside the residence or structure), such as a central office, and operating under the control of the DSL service provider).

A centralized line test system, deployed upstream of the ATU-R modem, sees very little, if any, of the high frequency noise environment local to a customer's residence or structure due to line loss and high levels of high-frequency cross-talk present upstream of the customer's residence or structure.

Heretofore, prior solutions recorded a snapshot of the noise environment and signal-to-noise ratio (SNR) per DSL tone available at the ATU-R modem. However, these solutions rely on measurements made at showtime, defined as the successful completion of a DSL link between the customer's modem (ATU-R) and a DSL service provider's modem (ATU-C). Real-time measurements, however, are not available via these solutions and any DSL modem based measurement solutions are not available at all if synchronization between the customer's DSL modem (ATU-R) and the DSL service supplier's modem (ATU-C) is lost.

### SUMMARY OF THE INVENTION

The present invention is a device that is deployed in-line, immediately before (just upstream) of a customer's DSL modem (ATU-R). The device measures noise levels in a pair of conductors, a.k.a., a twisted-pair cable, that is utilized to deliver DSL services to the customer's residence or structure and determines whether the noise levels are below or above expected noise thresholds caused by crosstalk and naturally occurring sources of noise. The device can also determine whether the customer's modem (ATU-R) and the service provider's modem (ATU-C) are present and able to initiate a handshake to begin communication. The device can also recognize working or degraded service regardless of the synchronization state of the ATU-R and ATU-C modems. In addition, the device can also identify when an un-filtered telephone, facsimile machine, modem, or set top box would adversely affect DSL service.

The invention is intended primarily for in-home or residence (structure) use, to aid in the diagnosis and repair of the inside pair of wires utilized to deliver DSL services. Also or alternatively, the unit can be deployed at a network demarcation point, such as, without limitation, a so-called network interface device, to determine whether there might be a network fault as opposed to a wiring fault inside the home/residence/structure.

Specifically, the invention is an in-line radio frequency (RF) shielded module which tests differential noise levels on wiring (a pair of wires) connected to the module and measures signal+noise at handshake time (when the ATU-R and ATU-C DSL modems are establishing DSL connectivity), calculates maximum attainable bit-rate, and confirms whether the bandwidth available to the user is commensurate with the loss of signal from the central office/exchange. Missing or broken splitters (or micro-filters) can also be identified by monitoring the line for changes in noise background that are coincident with a change in the line feeding voltage.

More specifically, the invention is a method of testing the capacity of a network comprised of one or more (Tip-Ring) pairs of wires (6, 8, 8-1), an ATU-C modem (10), and an ATU-R modem (16) to support DSL services. The method comprises: (a) providing a test device (30) configured to be coupled to a pair of wires (8-1) in-line between the ATU-C modem (10) and the ATU-R modem (16). The test device (30) comprises: a controller (66); a DC sampling circuit (54) operative under the control of the controller (66); an AC sampling circuit (78) operative under the control of the controller (66); a first connector (38) for coupling the pair of wires (8-1) to a first end of a pair of internal conductors (200, 202) of the test device (30); a second connector (36) for coupling the ATU-R modem (16) to a second end of the pair of internal conductors (200, 202); and means for connecting (57, 76) operative under the control of the controller (66) for selectively connecting the AC sampling circuit (78) to the first end of the pair of internal conductors (200, 202), to the second end of the pair of internal conductors (200, 202), or to both the first and second ends of the pair of internal conductors (200, 202);

The method further comprises: (b) the DC sampling circuit (54) samples for a DC line feed or DC potential difference on the pair of internal conductors (200, 202) when the means for connecting (57, 76) is connecting the AC sampling circuit (78) to both the first and second ends of the pair of internal conductors (200, 202); (c) the AC sampling circuit (78) samples for AC noise on the first end of the pair of internal conductors (200, 202) when the means for connecting (57, 76) is connecting the AC sampling circuit (78) to the first end of the pair of internal conductors (200, 202) while isolating the second end of the pair of internal conductors (200, 202) from the AC sampling circuit (78); (d) the AC sampling circuit (78) also samples for DSL signals on the second end of the pair of internal conductors (200, 202) when the means for connecting (57, 76) is connecting the AC sampling circuit (78) to the second end of the pair of internal conductors (200, 202) while isolating the first end of the pair of internal conductors (200, 202) from the AC sampling circuit (78); (e) the AC sampling circuit (78) also samples for DSL signals on the pair of internal conductors (200, 202) when the means for connecting (57, 76) is connecting the AC sampling circuit (78) to both the first and second ends of the pair of internal conductors (200, 202); and (f) based on the foregoing samplings, the controller (66) determines the capacity of the network to support DSL services, wherein during the samplings the test device (30) is coupled to the pair of wires (8-1) in-line between the ATU-C modem (10) and the ATU-R modem (16).

The means for connecting can include: a first relay (57) operative under the control of the controller (66) for selectively connecting and disconnecting the AC sampling circuit (78) to and from the first end of the pair of internal conductors (200, 202); and a second relay (76) operative under the control of the controller (66) for selectively connecting and disconnecting the AC sampling circuit (78) to and from the second end of the pair of internal conductors (200, 202).

The controller (66) can operate under the control of non-transitory computer software code.

The test device (30) can include an indicator (46 and/or 48) operative under the control of the controller (66). The controller (66) can causing the indicator to output an indication of the controller (66) determined capacity of the network to support DSL services.

The indicator can include at least one lamp (46) for outputting light as the indication of the determined capacity of the network to support DSL services, the at least one lamp outputting first and second colors in response to the controller (66) determining that the network is respectively capable and not capable of supporting DSL services. Also or alternatively, the indicator can include a display (48) for outputting a first visual pattern in response to the controller (66) determining that the network is capable of supporting DSL services and for outputting a second visual pattern in response to the controller (66) determining that the network is not capable of supporting DSL services.

The test device (30) can further include a network analyzer (60) operative under the control of the controller (66). The method can further include: (g) the network analyzer (60) outputting one or more AC signals to the pair of wires (8-1) via the pair of internal conductors (200, 202); (h) the AC sampling circuit (78) sampling the pair of wires (8-1) for the response to the one or more AC signals output by the network analyzer (60) in step (g); and (i) the controller responsive to the sampled response of the AC sampling circuit (78) in step (h) for determining the presence or absence of at least one DSL service affecting condition.

The at least one DSL service affecting condition can include at least one of the following: an impedance that is either higher or lower than a predetermined impedance threshold; and the presence of a bridged tap.

In step (e), the AC sampling circuit (78) can sample at least one of the following: DSL tones transmitted during restoration of communication between the ATU-C modem (10) and the ATU-R modem (16); and DSL tones transmitted between the ATU-C modem (10) and the ATU-R modem (16) after restoration of communication between the ATU-C modem (10) and the ATU-R modem (16).

The test device (30) can be coupled in-line with the pair of wires (8-1) between the ATU-R modem (16) which is deployed inside of a structure and a network interface device (4) which is mounted to the structure, wherein the network interface device (4) is coupled in-line with the pair of wires (8-1) between the ATU-R modem (16) and the ATU-C modem (10).

The second connector (36) of the test device (30) can be coupled directly to the ATU-R modem (16).

The invention is also a method of testing the capacity of a network comprised of one or more pairs of wires (6, 8, 8-1), an ATU-C modem (10), and an ATU-R modem (16) to support DSL services. The method comprises: (a) with the ATU-R modem (16) operatively coupled to an ATU-C modem (10) via a pair of wires (8-1), sampling for a DC line feed or DC potential difference on the pair of wires (8-1); (b) with the ATU-R modem (16) electrically isolated from the ATU-C modem (10) which is operatively coupled to the pair of wires (8-1), sampling for AC noise present on the pair of wires (8-1); (c) with the ATU-C modem (10) electrically isolated from the ATU-R modem (16), sampling for DSL signals output by the ATU-R modem (16); (d) with the ATU-R modem (16) operatively coupled to the ATU-C modem (10) via the pair of wires (8-1), sampling for DSL signals on the pair of wires (8-1); and (e) based on the sampling in steps (a), (b), (c), and (d), determining the capacity of the network to support DSL services.

Step (d) can include sampling for DSL signals during and following restoration of handshake between the ATU-C modem (10) and the ATU-R modem (16).

Step (e) can include illuminating a lamp, generating a visual pattern, or both in response to the determined capacity of the network to support DSL services.

The capacity of the network to support DSL services determined in step (e) can include at least one of the following: a number useable DSL tones; a number unusable DSL tones; insertion loss; signal-to-noise ratio per DSL tone; bit-loading per DSL tone; crest factor per DSL tone; maximum data rate per DSL tone; and maximum total data rate for all useable DSL tones.

Lastly, the invention is a test device (30) for testing the capacity of a network comprised of one or more pairs of wires (6, 8, 8-1), an ATU-C modem (10), and an ATU-R modem (16) to support DSL services. The test device (30) comprises: a controller (66); a DC sampling circuit (54) operative under the control of the controller (66); an AC sampling circuit (78) operative under the control of the controller (66); a first connector (38) for coupling a pair of wires (8-1) to a first end of a pair of internal conductors (200, 202) of the test device (30); a second connector (36) for coupling the ATU-R modem (16) to a second end of the pair of internal conductors (200, 202); and means for connecting (57, 76) operative under the control of the controller (66) for selectively connecting the AC sampling circuit (78) to the first end of the pair of internal conductors (200, 202), to the second end of the pair of internal conductors (200, 202), or to both the first and second ends of the pair of internal conductors (200, 202).

The means for connecting can include: a first relay (57) operative under the control of the controller (66) for selectively connecting and disconnecting the AC sampling circuit (78) to and from the first end of the pair of internal conductors (200, 202); and a second relay (76) operative under the control of the controller (66) for selectively connecting and disconnecting the AC sampling circuit (78) to and from the second end of the pair of internal conductors (200, 202).

The test device can further include a network analyzer (60) operative under the control of the controller (66), wherein, under the control of the controller (66) the means for connecting (57, 76) is operative for selectively connecting and disconnecting the network analyzer (60) to and from at least one of the following: the first end of the pair of internal conductors (200, 202), the second end of the pair of internal conductors (200, 202), or the both the first and second ends of the pair of internal conductors (200, 202) simultaneously.

The one or more of the pairs (6, 8, 8-1) of wires can be twisted pairs.

### BRIEF DESCRIPTION OF THE DRAWINGS

FIG. 1 is an exemplary residence, structure or home including wiring/cabling for distribution of telephony and DSL services;

FIG. 2 is a perspective view of the device shown in FIG. 1 connected in-line in an unfiltered extension of the internal cable of the residence, structure or home shown in FIG. 1 that services an ATU-R modem;

FIG. 3 is a schematic diagram of the internal electrical components of the device shown in FIG. 2; and

FIG. 4 is an exemplary flow diagram of a method of operation of the device shown in FIGS. 2 and 3.

### DETAILED DESCRIPTION OF THE INVENTION

The present invention will be described with reference to the accompanying figures where like reference numbers correspond to like elements.

With reference to FIG. 1, an exemplary residence, structure or home 2 (hereinafter “residence 2”) can include a network interface device 4 which facilitates connection of an external pair of wires (Tip-Ring pair) or twisted-pair cable 6 to an internal pair of wires (Tip-Ring pair) or twisted-pair cable 8. Typically, the wires of cable 6 and 8 are copper wires. However, this is not to be construed as limiting the invention.

Opposite network interface device 4, cable 6 is operatively connected to a service provider's DSL modem (ATU-C) 10. As is known in the art, a path 12 between modem 10 and cable 6 can include, for example, without limitation, one or more of the following: a central office (CO), a toll office (TO), a remote terminal (RT), and/or other network demarcation points.

In one non-limiting embodiment, the CO typically houses the main telephony switching equipment for the residence 2 and can serve as the location for the DSL service provider's modem (ATU-C). In one non-limiting embodiment, the TO and the RT are connected by one or more pairs of wires (or twisted-pair cables), and the CO is connected to the TO via a fiber optic link. This discussion, however, of elements that can comprise path 12 and where the DSL service provider's DSL modem (ATU-C) 10 is deployed is not to be construed as limiting the invention since it is envisioned that path 12 can be any suitable and/or desirable combination of twisted-pair cable and fiber optics, and that the service provider's DSL modem 10 can be deployed at any suitable and/or desirable network point that facilitates the provision of DSL broadband service to residence 2 via cable 6.

In the embodiment of residence 2 shown in FIG. 1, the customer's DSL modem (ATU-R) 16 is connected to an unfiltered extension 8-1 of cable 8. A computer 18 can be coupled to modem 16 via an Ethernet connection 20 in a manner known in the art. The illustration in FIG. 1 of customer's DSL modem 16 being connected directly to computer 18, however, is not to be construed as limiting the invention since it is envisioned that two or more computers 18, or other Ethernet enabled devices, can be connected to customer's DSL modem 16 via a router (not shown) in a manner known in the art, e.g., via wired or wireless connections. Moreover, the illustration of Ethernet connection 20 in FIG. 1 as being a hard-wired connection is not to be construed as limiting the invention since it is envisioned that Ethernet connection 20 between computer 18 and modem 16 can be a wired or wireless connection.

Residence 2 can optionally include one or more unfiltered extensions 8-2 and 8-3 of cable 8 coupled to a set top box (STB) receiver 22 and a facsimile machine 24, respectively. STB receiver 22 includes an internal modem that converts incoming DSL signals containing TV programming into audio and/or visual signals for display on a television 26 connected to STB receiver 22. Modem 22 may also include a so-called back-channel modem that facilitates communication from STB receiver 22 to the service providers DSL modem 10.

Residence 2 can optionally include an unterminated blind extension 8-4 of cable 8. Lastly, residence 2 can optionally include a filtered extension 8-5 of cable 8 coupled to a conventional POTS telephone 26. This filtered extension 8-5 includes an in-line microfilter 28 that is utilized to separate telephone signals from the incoming DSL signals in a manner known in the art, i.e., a low pass filter.

In accordance with the present invention, unfiltered extension 8-1 includes an in-line module or device 30 that is configured to perform a number of measurements to be described in greater detail next.

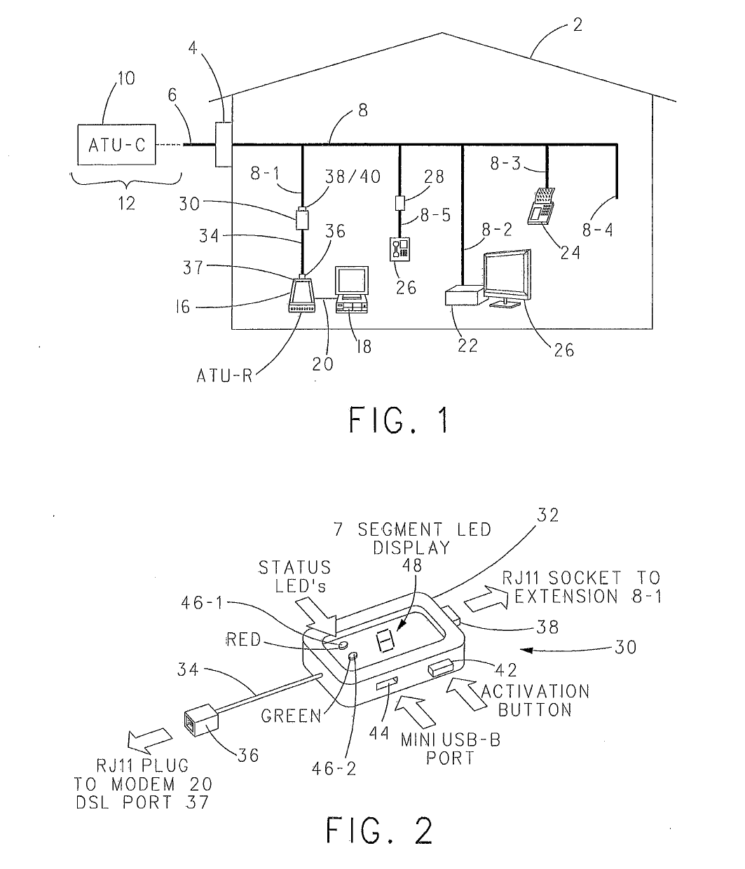

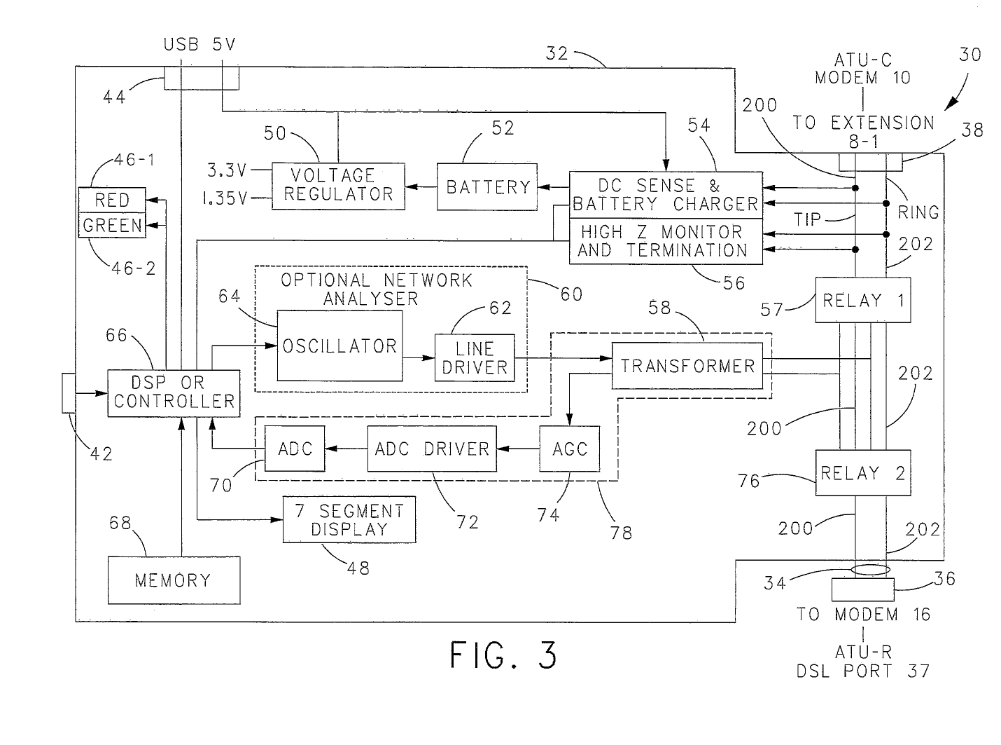

With reference to FIG. 2 and with continuing reference to FIG. 1, device 30 is comprised of an RF shielded box or housing 32 that houses, among other things, a power supply and electronic testing circuitry which is discussed in greater detail hereinafter. Device 30 also includes a cable 34 including an RJ 11 plug 36 at the end of cable 34 opposite housing 32 for connection to an RJ11 socket 37 or DSL port of modem 16, an RJ 11 socket 38 for connection to an RJ 11 plug 40 of unfiltered extension 8-1, an activation button 42, a USB port 44 (desirably a mini USB-B port), one or more status LEDs 46, and a suitable display 48, such as, without limitation, a 7-segment LED display.

With reference to FIG. 3 and with continuing reference to FIGS. 1 and 2, housing 32 of device 30 houses electronic testing circuitry components that either alone or in combination form the functional blocks shown and connected in the manner illustrated in FIG. 3. Specifically, the interior of housing 32 houses the components of device 30 that form the following functional blocks connected in the manner shown in FIG. 3: a voltage regulator block 50, a rechargeable battery block 52, a DC sense and battery charger block 54, a high Z monitor and termination block 56, a first relay block 57, an impedance matching/isolation transformer block 58, an optional network analyzer block 60 comprising a line driver block 62 and an oscillator block 64, a digital signal processor (DSP) or controller block 66, a memory block 68 operative for storing, among other things, non-transitory computer program code that DSP 66 operates under the control of, an analog-to-digital converter (ADC) block 70, an ADC driver block 72, an automatic gain control (AGC) block 74, and a second relay block 76. Each block of device 30 can include any number of electrical or electronic components that facilitate the function of the block in the manner to be described hereinafter or understood by one of ordinary skill in the art. Accordingly, the blocks of the block diagram of device 30 shown in FIG. 3 are not to be construed as limiting the invention.

In the non-limiting embodiment of device 30 shown in FIG. 3, status LEDs 46 include a red LED 46-1 and a green LED 46-2 operative under the control of DSP 66. Display 48, for example, without limitation, a 7-segment display, is also operative under the control of DSP 66.

First relay block 57 and second relay block 76 are operative under the control of DSP 66. In one state, first relay block 57 and second relay block 76 connect plug 36 and socket 38 in a “through” connection whereupon socket 38 and plug 36 are directly connected via first relay block 57, second relay block 76, and a pair of internal conductors (Tip-Ring pair) 200 and 202 of device 30 that run between socket 38 and plug 36 via first and second relay blocks 57 and 76.

Under the control of DSP 66, first and second relay blocks 57 and 76 can be independently controlled to selectively connect transformer 58 to socket 38 or plug 36 while electrically isolating plug 36 and socket 38, respectively, from transformer 58. Under the control of DSP 66, first and second relay blocks 57 and 76 can be controlled to connect transformer 58 to socket 38 and plug 36 via relay blocks 57 and 76.

USB port 44 enables DSP 66 to communicate with an external intelligent device, such as, without limitation, a PC or any other suitable type of intelligent controller. By way of USB port 44, DSP 66 can dispatch to an external intelligent controller coupled to device 30 via USB port 44 any data accumulated by DSP 66 and/or any calculation made of data processed by DSP 66. In this regard, DSP 66 can receive data from an AC sampling circuit comprised of transformer 58, AGC 74, ADC driver 72 and ADC 70, optionally but desirably process said data, and forward the received and/or processed data to any suitable and/or desirable external intelligent controller via USB port 44 in a manner known in the art. This external intelligent controller can be programmed to further analyze any such data and/or to act as a repository for data received and processed by DSP 66 at different times. In addition, by way of a 5-volt power line that is part of a conventional USB connection, power can be supplied from the external intelligent controller to device 30 via USB port 44 for use by voltage regulator block 50 to supply power to other components of device 30 and/or for use by the battery charger portion of block 54 for charging rechargeable battery 52.

In operation, device 30 desirably provides one or more of the following functionality:
A1) Locally activated test and diagnostic sequence;
A2) Locally activated monitor for interactive test;
A3) Locally activated demand test and full results retrieval; and
A4) Remotely activated demand test and results retrieval.

Once active, device 30 desirably detects and/or measures one or more of the following:
B1) One or both wires of cable 8 disconnected (detects DC line feed on one or both wires of extension 8-1);
B2) Background noise levels per tone (breaks synchronization to measure quiet line noise (QLN));
B3) ATU-R powered and active (detects certain predetermined DSL tones, on handshake);
B4) ATU-C powered and active (detects handshake response to ATU-R pilot tones);
B5) Signal+noise prior to channel analysis;
B6) Level measurements, including peak and mean;
B7) Rapid changes in measured levels across the broadband spectrum; and
B8) Changes in DC line feed voltage.

One or more of the following can be calculated by device 30:
C1) Insertion loss from QLN (uses level and profile to estimate loss);
C2) Signal level per DSL tone (signal+noise measured in B5 above−noise measured in B2 above);
C3) Insertion loss (assuming maximum send level cf receive level at ATU-R);
C4) Signal-to-Noise Ratio per DSL tone (SNR per DSL tone using signal level from C2 above and QLN from B2 above per DSL tone);
C5) Bit loading (based on an SNR margin (SNRM) of 6 dB);
C6) Maximum attainable bit-rate (based on 4000×total bit-loading from C5); and
C7) Crest factors for signal and noise values.

Device 30 can analyze the above (B1-B8 and C1-C7) to determine the following:
D1) One or both wires disconnected (lack of DC line feed);
D2) ATU-R missing or non-functional (e.g., a predetermined DSL tone is below an acceptable threshold T1);
D3) ATU-C missing or non-functional (ATU-C pilot tones missing or below a threshold T2);
D4) Signal level poor (more than XdB attenuation at 300 kHz or an equivalent threshold T3);
D5) Noise level too high (more than Y % of spectrum above worst case noise for equivalent ultra short line, threshold T4);
D6) Noise/Signal classifiers (Crest factor analysis, D1 cross-talk, D2 signal, D3 impulse, D4 natural); and
D7) Line quality assessment (A Tested OK indication or potential fault or noise indication).

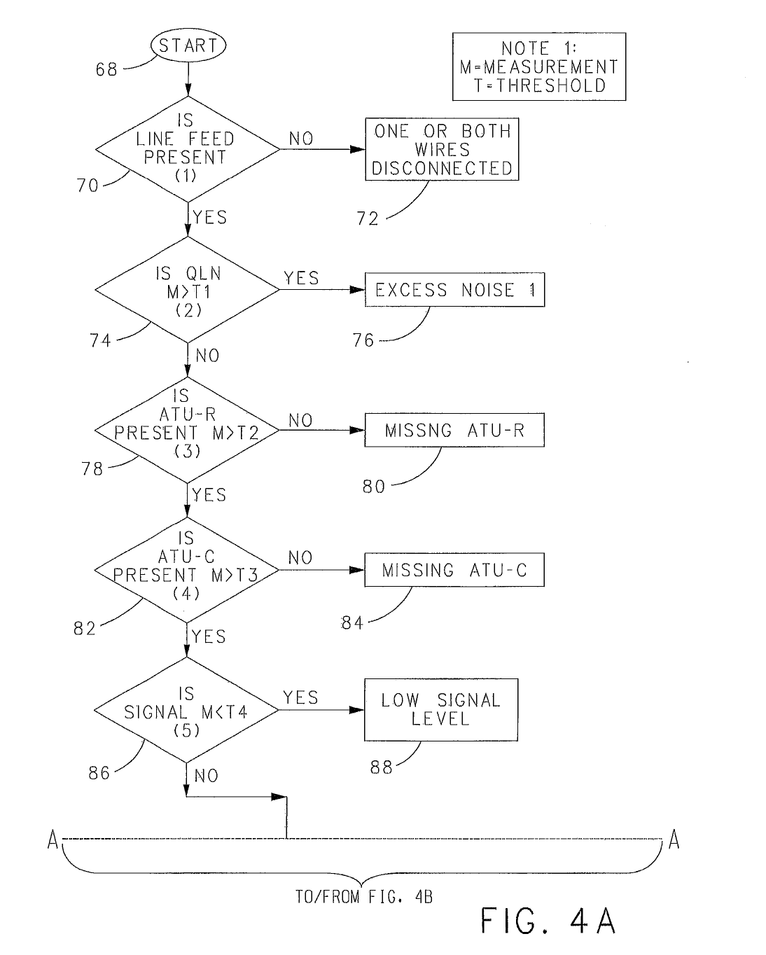

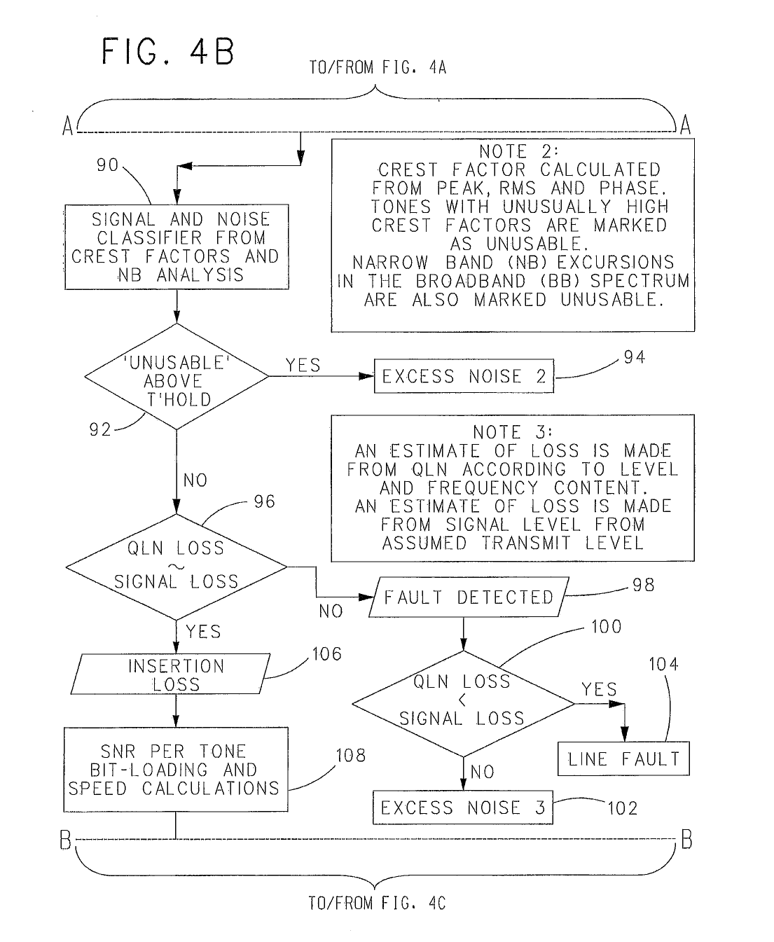

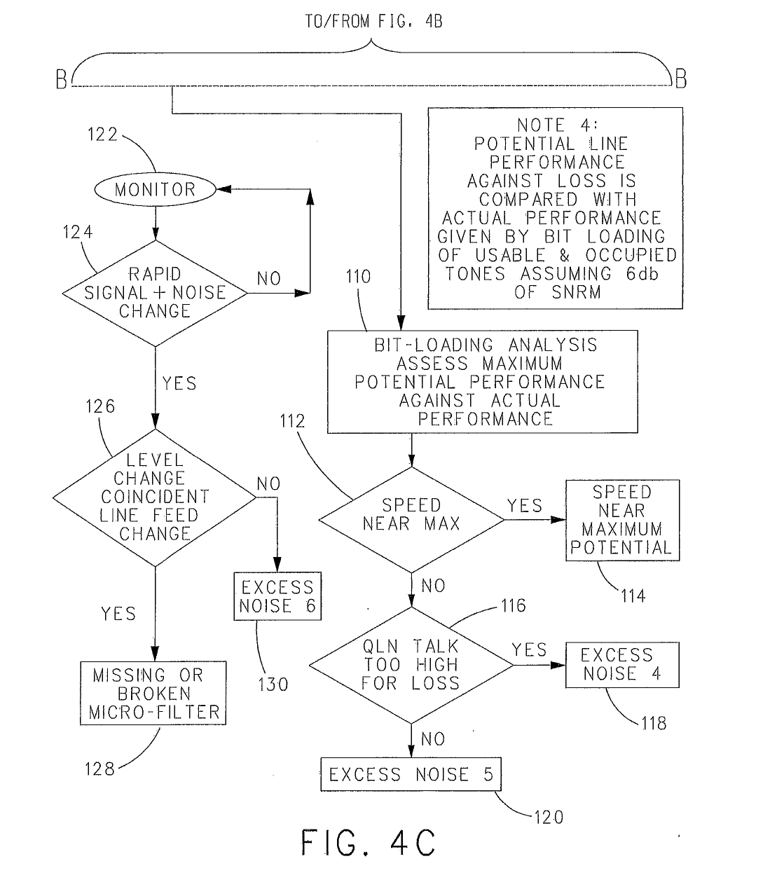

An exemplary, non-limiting test sequence illustrative of the capabilities of device 30 will now be described with reference to the method embodied in the flowchart of FIG. 4. In connection with the discussion of this method, it will be assumed that plug 36 is operatively coupled to modem 16 and that socket 38 is operatively coupled to extension 8-1.

Initially, the method commences by advancing from start step 68 to step 70 in response to user activation of activation button 42. In step 70, device 30 determines if a DC line feed is present. For this test, DSP 66 determines via the DC sense part of block 54 if a suitable DC line feed voltage is impressed on the pair of conductors 200 and 202 (e.g., the Tip-Ring pair) of device 30 that connect to the Tip-Ring conductors of extension 8-1 and the Tip-Ring conductors of cable 34. To this end, the DC sense portion of block 54 is a volt meter that is configured and connected to detect DC line feed and changes in DC line feed appearing on conductors 200 and 202.

If DSP 66 via the DC sense part of block 54 determines that DC line feed is not present, the method advances to steps 72 where DSP 66 causes red LED 46-1 to illuminate and causes display 48 to output a visual pattern indicative of the method advancing to step 72.

However, if in step 70, however, DSP 66 determines that DC line feed is present, the method advances to step 74 wherein DSP 66 determines if a measured quiet line noise (QLN) is greater than a predetermined threshold T1 stored in memory 68. For the test of step 74, DSP 66 controls first and second relays 57 and 76 couple transformer 58 in communication with ATU-C modem 10 via extension 8-1 but isolate from transformer 58 ATU-R modem 16. After waiting a sufficient time for ATU-C modem 10 to stop transmission after breaking the connection with ATU-R modem 16, DSP 66, via the AC sampling circuit 78 (comprised of transformer 58, AGC 74, ADC driver 72, and ADC 70) performs a noise level measurement on the conductive wires (Tip-Ring pair) that run between transformer 58 and ATU-C modem 10.

If, via the measurement of step 74, DSP 66 determines that the measured QLN is greater than threshold T1, the method advances to step 76 wherein DSP 66 causes red LED 46-1 to illuminate and causes display 48 to display a visual pattern indicative of the method advancing to step 76.

However, if the measured QLN is ≦threshold T1, the method advances to step 78 wherein DSP 66 determines if customer modem 16 is present. To perform this test, DSP 66 sets first and second relays 57 and 76 so that ATU-C modem 10 is isolated from transformer 58 and ATU-R modem 16 is electrically connected in communication with transformer 58 via, among other things, second relay 76, cable 34, and plug 36. Thereafter, via the AC sampling circuit 78, DSP 66 determines if ATU-R modem 16 is present by detecting for the presence of one or more DSL tones used by ATU-R modem 16 to communicate with ATU-C modem 10. More specifically, DSP 66 determines if measured values of each of one or more DSL tones is greater than one or more predetermined thresholds T2. Each DSL tone can be compared to a single predetermined threshold D2. Also or alternatively, each DSL tone can be compared to a unique threshold for said DSL tone or a plurality of thresholds can be provided for comparison to one or a number of DSL tones. If so, the method advances to step 82.

However, if DSP 66 does not detect any DSL tones or detects that one or more DSL tones have a measured value (e.g., RMS value) that is less than or equal to a desired threshold, DSP 66 interprets this condition as ATU-R modem 16 either being powered off, not connected, or not functioning properly, or that a problem exists in the wiring between device 30 and ATU-R modem 16. In this case, the method advances from step 78 to step 80 where DSP causes red LED 46.1 to illuminate and causes display 48 to display a visual pattern indicative of the method advancing to step 80.

Assuming that the method has advanced to step 82 from step 78 where the proper operation of ATU-R modem 16 was confirmed, DSP 66 in step 82 determines if ATU-C modem 10 is present. To perform this test, DSP 66 sets first and second relays 57 and 76 so that the connection between ATU-C modem 10 and ATU-R modem 16 is restored and transformer 58 is coupled to conductors 200 and 202 that connect ATU-C modem 10 and ATU-R modem 16. In response to restoring this connection, modems 10 and 16 commence handshaking utilizing DSL tones in a manner known in the art. Via AC sampling circuit 78, DSP 66 determines if these handshaking DSL tones are present and if each handshaking DSL tone has an amplitude greater than a predetermined threshold T3, that is either unique to said DSL tone or common to one or more DSL tones. If so, the method advances to step 86. If not, however, the method advances to step 84 wherein DSP 66 causes red LED 46-1 to illuminate and causes display 48 to display a visual pattern indicative of the method advancing to step 84.

In step 86, DSP 66 causes AC sampling circuit 78 to continue measuring signal levels in the xDSL frequency range while ATU-C modem 10 and ATU-R modem 16 are connected. DSP 66 compares the measured signal levels to quiet line noise (QLN) levels to determine if the signal levels are of sufficient strength for DSL communications.

If DSP 66 determines that the measured signal level(s) for DSL frequencies is less than a predetermined threshold T4 common to a number of DSL frequencies, the method advances to step 88 where DSP 66 causes red LED 46-1 to illuminate and causes display 48 to display a visual pattern indicative of the method advancing to step 88. On the other hand, if DSP 66 determines that the measured signal level(s) for DSL frequencies is NOT less than a predetermined threshold T4, the method advances from step 86 to step 90.

For each of steps 74, 78, 82, and 86, DSP 66 compares a measured value (amplitude) of at least one DSL tone (frequency) to a threshold T. However, it is envisioned for each of steps 74, 78, 82, and 86 that the values of two or more DSL tones (frequencies) can be compared to a single threshold for each step or multiple thresholds. For example, in step 86, a measured value of a first DSL frequency can be compared to a first threshold T4-1, a value of a second measured DSL frequency can be compared to a second threshold T4-2, and so forth.

In step 74, DSP 66 performed a quiet line noise (QLN) measurement with ATU-R modem 16 isolated from ATU-C modem 10. Noise detected by this measurement typically is comprised of a mixture of natural noise, crosstalk noise from adjacent pairs of wires, induced impulse noise from external sources, and radio noise, e.g., from AM radio stations. Measurements from step 74 can include peak, mean and phrase values for each DSL tone in the DSL frequency range. In step 90, a further parameter—crest factor—is calculated as the peak-to-average power ratio for each DSL tone.

The method then advances from step 90 to step 92 wherein the crest factor for each DSL tone is compared to a threshold for said DSL tone or to a threshold common to a number of DSL tones, including all of the DSL tones. If the crest factor for any one DSL tone is above this threshold, this DSL tone is deemed to have excessive noise. In one non-limiting embodiment, for each DSL tone, DSP 66 compares the measured QLN determined in step 74 for said tone to the crest factor determined for said DSL tone in step 90. If DSP 66 determines that the measured QLN for said DSL tone determined in step 74 and the crest factor for said DSL tone determined in step 90 differ by more than 10 dB, for example, then, in step 92 a fault is declared for said DSL tone whereupon said tone is deemed unusable. Step 92 determines whether each DSL tone is usable or unusable. If some predetermined number of DSL tones or some predetermined percentage of the total number of DSL tones is deemed unusable, the method advances to step 94 indicative of excess noise whereupon DSP 66 causes red LED 46-1 to illuminate and causes display 48 to display a visual pattern indicative of the method advancing to step 94. For example, step 92 can be programmed such that if 20% of the xDSL spectrum is deemed unusable, the method advances to step 94.

If, in step 92, DSP 66 determines that a sufficient number of xDSL tones are usable, i.e., less than a threshold number of tones are unusable, the method advances to step 96 where DSP 66 determines if the QLN loss is approximately equal (e.g., ≦10 dB) to the signal loss for each tone. The values of QLN loss used in step 96 are determined from the measured values of QLN in step 74 according to amplitude and frequency content. An estimate of QLN loss is made from the measured value of QLN in step 74 according to amplitude and frequency content. An estimate of signal loss is made from a signal level and from an assumed transmit level.

Specifically, it is known that QLN noise determined by DSP 66 in step 74 should be dominated by crosstalk from pairs of wires adjacent to twisted-pair cables 6 and 8 (including, in the present example, extension 8-1). Closer to ATU-C modem 10, crosstalk is expected to be very high in level and extend across the entire DSL frequency spectrum. Moving further away from ATU-C modem 10, the level of crosstalk decreases and the DSL frequency spectrum changes such that the crosstalk is reduced for higher frequencies. Therefore, the level and frequency content of QLN noise measured in step 74 can be utilized by DSP 66 to estimate the distance device 30 resides from ATU-C modem 10 and, optionally, categorize said distance, e.g., without limitation, Ultra Short, Extra Short, Short, Medium, Long.

More specifically, in step 82, when ATU-C 10 modem 10 commences handshaking with ATU-R modem 16, ATU-C modem 10 transmits (outputs) on full power (amplitude) across the entire DSL frequency spectrum. Knowing the amplitude of each DSL tone output by ATU-C modem 10 during the commencement of handshaking with ATU-R modem 16 in step 82 and the measured amplitude of said DSL tone received by device 30 from ATU-C modem 10 in step 82, DSP 66 can determine a difference between these amplitudes as the signal loss between ATU-C modem 10 and device 30. Based on this signal loss, the approximate distance between ATU-C modem 10 and device 30 can be estimated.

If DSP 66 determines that the QLN loss for each of one or more DSL tones is similar to the signal loss for said DSL tone (e.g., without limitation, QLN loss and signal loss are within 10 dB), the DSL signal path (e.g., the pairs of wires or Tip-Ring pairs) that connect ATU-C modem 10 and device 30 is deemed by DSP 66 to be valid. However, if the QLN loss for each of one or more DSL tones is less than the signal loss for said DSL tone by a predetermined amount (e.g., QLN loss <10 dB of the signal loss), the DSL signal path (e.g., the pairs of wires or Tip-Ring pairs) that connect ATU-C modem 10 and device 30 is deemed by DSP 66 to have a physical fault and the method advances to step 98. Lastly, if the signal loss for each of one or more DSL tones is less than the QLN loss for said DSL tone by a predetermined amount (e.g., signal loss <10 dB of the QLN loss), the DSL signal path (e.g., the pairs of wires or Tip-Ring pairs) that connect ATU-C modem 10 and device 30 is deemed by DSP 66 to have an excess noise fault and the method advances to step 98.

If, in step 96 it is determined that QLN loss is not approximately equal to the signal loss, the method advances to step 98 where DSP 66 deems a fault to have been detected. The method then advances to step 100 where DSP determines if the QLN loss is less than the signal loss. If so, it is deemed that a line fault is present and the method advances to step 104 wherein DSP causes red LED 46-1 to illuminate and causes display 48 to display a visual pattern indicative of the method advancing to step 104.

On the other hand, if, in step 100, DSP 66 determines that the QLN loss is not less than the signal loss, DSP 66 deems the line to have excessive noise and the method advances to step 102 wherein DSP 66 causes red LED 46-1 to illuminate and causes display 48 to display a visual pattern indicative of the method advancing to step 102.

However, if DSP 66 determines in step 96 that QLN loss is approximately equal to signal loss (e.g., QLN loss ≦10 dB of the signal loss), the method advances to step 106 wherein DSP 66 determines insertion loss based on the measured values of QLN in step 74 and, more specifically, from a QLN profile, level and slope, collectively called the QLN loss. DSP 66 can also calculate insertion loss based on the signal strength (amplitude) detected by AC sampling circuit 78 under the control of DSP 66. Desirably, insertion loss determined in this latter manner is determined at a single frequency within the DSL frequency spectrum, e.g., 300 kHz.

Following step 106, the method advances to step 108 where DSP 66 performs signal to noise ratio (SNR) per tone, bit-loading, and speed calculations. To determine the SNR per tone in dB, DSP 66 utilizes the formula 10 log₁₀

$$\frac{{v}_{1}^{2}}{{v}_{2}^{2}} ,$$

where v₁ is the measured value (e.g., RMS value) for said tone from step 86 and v₂ is the measured value (e.g., RMS value) of QLN for said tone from in step 74.

Bit-loading for a set signal-to-noise (SNR) ratio margin, e.g., SNRM=6 dB, is determined by DSP 66 against the following rules for each DSL tone not deemed unusable in step 92: (1) if SNR is <SNRM then bit-loading equals 0 and said DSL tone is marked unusable; (2) if (SNR−SNRM)÷3 is >15, then bit-loading for said DSL tone is set to 15; and (3) otherwise bit-loading for said DSL tone is set equal to (SNR−SNRM)÷3.

The total bit-loading can then be calculated by DSP 66 by summing the bit-loading per DSL tone across the xDSL frequency spectrum of interest. DSP 66 can then determine the maximum data rate from the bit-loading. For example, the total bit-loading is calculated by DSP 66 by simply adding together the bit-loading per DSL tone determined across the xDSL frequency spectrum of interest. The maximum data rate can then be determined by DSP 66 by multiplying the total bit-loading by a desired value (e.g., 4000) to express the maximum speed in desired terms, e.g., millions of bits per second (Mbps).

The method then advances to step 110 wherein DSP 66 performs a bit-loading analysis that assesses maximum potential performance against actual performance. More specifically, in step 110 DSP 66, assuming 6 dB of SNRM, compares the actual maximum data rate determined in step 108 for the usable and occupied xDSL tones to the potential performance for said usable xDSL tones stored in memory 68 that was determined from theoretical data or empirical data desirably obtained under similar physical circumstances as the wiring of residence 2 shown in FIG. 1.

The method then advances to step 112 wherein DSP 66 determines if the actual performance is within a predetermined percentage or range, e.g., without limitation 80%, of the maximum potential performance. If so, the method advances to step 114 where DSP 66 causes green LED 46-2 to illuminate (indicative of the method of FIG. 4 passing) and causes display to display a visual pattern indicative of the method advancing to step 114.

If, however, in step 112 DSP 66 determines that the actual performance is not within a desired percentage or range of the maximum potential performance the method advances to step 116.

In step 116, DSP 66 determines if the measured values of QLN determined in step 74 are too high for the signal loss determined in step 82. For example, if DSP 66 determines that QLN>signal loss by more than a first predetermined value, e.g., without limitation, 6 dB, the method advances to step 118. Otherwise, the method advances to step 120. Regardless of which step 118 or 120 the method advances, DSP 66 causes red LED 46-1 to illuminate and causes display 48 to display a visual pattern indicative of the method advancing to said step.

As should be appreciated from the foregoing description, that whenever the method of FIG. 4 advances to any of steps 72, 76, 80, 84, 88, 94, 102, 104, 114, 118, or 120, the method stops executing. Thus, for example, if the method advances to step 72, step 74 and so forth are not executed.

Upon the method of FIG. 4 terminating its execution, the user may terminate testing and turn-off device 30 by depressing activation button 42 a second time. Absent activating activation button 42 a second time DSP 66, at a suitable time, will branch to a monitor subroutine represented by steps 122-130. More specifically, the method will advance from any one of steps 72, 76, 80, 84, 88, 94, 102, 104, 114, 118, or 120 to monitor step 122. From monitor step 122, the method advances to step 124 where DSP 66 monitors for rapid signal+noise changes on conductors 200 and 202. In this step, DSP monitors for rapid signal+noise changes on conductors 200 and 202 by setting first and second relays 57 and 76 to a state where AC sampling circuit 78 can monitor for any such changes.

If, in step 124, a rapid signal+noise change is not detected, the method returns to step 122 and thereafter, continuously loops on steps 122 and 124. However, if, in any iteration of step 124, a rapid signal+noise change is detected, the method advances to step 126 wherein DSP 66 determines if the rapid change is coincident with a DC line feed change. If so, the DSP 66 deems micro-filter 28 to be broken or missing and the method advances to step 128. If not, DSP 66 deems the line to contain excessive noise and the method advances to step 130. Regardless if the method advances to either step 128 or 130 from step 126, DSP 66 causes red light 46-1 to illuminate and causes display 48 to display a visual pattern indicative of the method advancing to said step from step 126.

As can be seen, the present invention is a device 30 that is placed immediately before the residential gateway, i.e., ATU-R modem 16. The device 30 measures noise levels in pairs of wires, e.g., twisted-pair cable 8 and extension 8-1, that feed DSL signals to ATU-R modem 16 and determines whether the measured noise levels are below or above expected noise thresholds caused by crosstalk and other sources of noise. The device 30 also determines whether the ATU-C modem 10 and the ATU-R DSL modem 16 are present and able to initiate a handshake to begin communication. Device 30 is capable of recognizing working or degraded service regardless of the synchronization states of modems 10 and 16. By way of signal and noise measurements, device 30 can indirectly determine if an unfiltered extension, fax machine, micro-filter, telephone, or set top box would adversely affect xDSL broadband service.

In the foregoing description, each cable 6 and 8, each extension 8-1-8-5 and cable 34 is assumed to have a pair of conductive wires, albeit twisted or untwisted pairs, that act as the Tip-Ring pairs of conventional wiring utilized to deliver telephony services.

Referring back to FIG. 3, device 30 can optionally include network analyzer 60, comprising oscillator 64 and line driver 62, operative under the control of DSP 66. In operation, network analyzer 60 can be controlled by DSP 66 to output one or more AC signals to extension 8-1 via transformer 58, relay 57 and the portion of conductors 200 and 202 that extend from relay 57 to socket 38. DSP 66 can control AC sampling circuit 78 to sample the response of extension 8-1 to the one or more AC signals output by network analyzer 60. Via AC sampling circuit 78, DSP 66 can determine from the sampled response of extension 8-1 to the AC signals output by network analyzer 60 the presence or absence of at least one DSL service affecting condition of cable 8 that can be sensed via extension 8-1. Examples of DSL service affecting conditions include an impedance that is either higher or lower than a predetermined impedance threshold or the presence of a bridged tap.

AC signals output by network analyzer 60 can be generated in the range from 20 Hz to 2.2 MHz (for testing in the ADSL2+ environment), and optionally up to 30 MHz (for testing in the VDSL band). Moreover, it is envisioned that device 30 can be configured to recognize and generate handshake ATU-R tones. It is envisioned that this configuration requires several differential phase shift keying (DPSK) of several DSL carrier tones. The capability of recognizing and generating handshake ATU-R tones is provided by the combination of DSP 66, network analyzer 60, and AC sampling circuit 78.

Moreover, it is envisioned that device 30 can also have the capacity to recognize handshake ATU-C tones via AC sampling circuit and DSP 66. This also requires DPSK of several DSL carrier tones.

Lastly, device 30, and specifically, the combination of DSP 66 and AC sampling circuit 78, can enable device 30 to act as a modem. The ability of device 30 to act as a modem provides for remote access capability of device 30 from, for example, ATU-C modem 10.

This invention has been described with reference to exemplary embodiments. Obvious modifications and alterations will occur to others upon reading and understanding the preceding detailed description. It is intended that the invention be construed as including all such modifications and alterations insofar as they come within the scope of the appended claims or the equivalents thereof.

The invention claimed is:

1. A method of testing the capacity of a network comprised of one or more pairs of wires (6, 8, 8-1), an ATU-C modem (10), and an ATU-R modem (16) to support DSL services, the method comprising:
(a) providing a test device (30) configured to be coupled to a pair of wires (8-1) in-line between the ATU-C modem (10) and the ATU-R modem (16), the test device (30) comprising:
a controller (66);
a DC sampling circuit (54) operative under the control of the controller (66);
an AC sampling circuit (78) operative under the control of the controller (66);
a first connector (38) for coupling the pair of wires (8-1) to a first end of a pair of internal conductors (200, 202) of the test device (30);
a second connector (36) for coupling the ATU-R modem (16) to a second end of the pair of internal conductors (200, 202); and
means for connecting (57, 76) operative under the control of the controller (66) for selectively connecting the AC sampling circuit (78) to the first end of the pair of internal conductors (200, 202), to the second end of the pair of internal conductors (200, 202), or to both the first and second ends of the pair of internal conductors (200, 202);
(b) the DC sampling circuit (54) sampling for a DC line feed on the pair of internal conductors (200, 202) when the means for connecting (57, 76) is connecting the AC sampling circuit (78) to both the first and second ends of the pair of internal conductors (200, 202);
(c) the AC sampling circuit (78) sampling for AC noise on the first end of the pair of internal conductors (200, 202) when the means for connecting (57, 76) is connecting the AC sampling circuit (78) to the first end of the pair of internal conductors (200, 202) while isolating the second end of the pair of internal conductors (200, 202) from the AC sampling circuit (78);
(d) the AC sampling circuit (78) sampling for DSL signals on the second end of the pair of internal conductors (200, 202) when the means for connecting (57, 76) is connecting the AC sampling circuit (78) to the second end of the pair of internal conductors (200, 202) while isolating the first end of the pair of internal conductors (200, 202) from the AC sampling circuit (78);
(e) the AC sampling circuit (78) sampling for DSL signals on the pair of internal conductors (200, 202) when the means for connecting (57, 76) is connecting the AC sampling circuit (78) to both the first and second ends of the pair of internal conductors (200, 202); and
(f) based on the sampling in steps (b), (c), (d), and (e), the controller (66) determining the capacity of the network to support DSL service, wherein in steps (b), (c), (d), and (e) the test device (30) is coupled to the pair of wires (8-1) in-line between the ATU-C modem (10) and the ATU-R modem (16).

2. The method of claim 1, wherein the means for connecting includes:
a first relay (57) operative under the control of the controller (66) for selectively connecting and disconnecting the AC sampling circuit (78) to and from the first end of the pair of internal conductors (200, 202); and
a second relay (76) operative under the control of the controller (66) for selectively connecting and disconnecting the AC sampling circuit (78) to and from the second end of the pair of internal conductors (200, 202).

3. The method of claim 1, wherein the controller (66) operates under the control of non-transitory computer software code.

4. The method of claim 1, wherein:
the test device (30) includes an indicator (46 and/or 48) operative under the control of the controller (66); and
step (f) includes the controller (66) causing the indicator to output an indication of the controller (66) determined capacity of the network to support DSL service.

5. The method of claim 4, wherein the indicator includes at least one lamp (46) for outputting light as the indication of the determined capacity of the network to support DSL service, the at least one lamp outputting first and second colors in response to the controller (66) determining that the network is respectively capable and not capable of supporting DSL service.

6. The method of claim 4, wherein the indicator includes a display (48) for outputting a first visual pattern in response to the controller (66) determining that the network is capable of supporting DSL service and for outputting a second visual pattern in response to the controller (66) determining that the network is not capable of supporting DSL service.

7. The method of claim 1, wherein the test device (30) further includes a network analyzer (60) operative under the control of the controller (66); and
the method further includes:
(g) the network analyzer (60) outputting one or more AC signals to the pair of wires (8-1) via the pair of internal conductors (200, 202);
(h) the AC sampling circuit (78) sampling the pair of wires (8-1) for the response to the one or more AC signals output by the network analyzer (60) in step (g); and
(i) the controller responsive to the sampled response of the AC sampling circuit (78) in step (h) for determining the presence or absence of at least one DSL service affecting condition.

8. The method of claim 7, wherein the at least one DSL service affecting condition includes at least one of the following:
an impedance that is either higher or lower than a predetermined impedance threshold; and
the presence of a bridged tap.

9. The method of claim 1, wherein, in step (e), the AC sampling circuit (78) samples at least one of the following:
DSL tones transmitted during restoration of communication between the ATU-C modem (10) and the ATU-R modem (16); and
DSL tones transmitted between the ATU-C modem (10) and the ATU-R modem (16) after restoration of communication between the ATU-C modem (10) and the ATU-R modem (16).

10. The method of claim 1, wherein the test device (30) is coupled in-line with the pair of wires (8-1) between the ATU-R modem (16) which is deployed inside of a structure and a network interface device (4) which is mounted to the structure, wherein the network interface device (4) is coupled in-line with the pair of wires (8-1) between the ATU-R modem (16) and the ATU-C modem (10).

11. The method of claim 1, wherein the second connector (36) of the test device (30) is coupled directly to the ATU-R modem (16).

12. A method of testing the capacity of a network comprised of one or more pairs of wires (6, 8, 8-1), an ATU-C modem (10) and an ATU-R modem (16) to support DSL service, the method comprising:
(a) with the ATU-R modem (16) operatively coupled to an ATU-C modem (10) via a pair of wires (8-1), sampling for a DC line feed on the pair of wires (8-1);
(b) with the ATU-R modem (16) electrically isolated from the ATU-C modem (10) which is operatively coupled to the pair of wires (8-1), sampling for AC noise present on the pair of wires (8-1);
(c) with the ATU-C modem (10) electrically isolated from the ATU-R modem (16), sampling for DSL signals output by the ATU-R modem (16);
(d) with the ATU-R modem (16) operatively coupled to the ATU-C modem (10) via the pair of wires (8-1), sampling for DSL signals on the pair of wires (8-1); and
(e) based on the sampling in steps (a), (b), (c), and (d), determining the capacity of the network to support DSL service.

13. The method of claim 12, wherein step (d) includes sampling for DSL signals during and following restoration of handshake between the ATU-C modem (10) and the ATU-R modem (16).

14. The method of claim 12, wherein step (e) further includes illuminating a lamp, generating a visual pattern, or both in response to the determined capacity of the network to support DSL service.

15. The method of claim 12, wherein the capacity of the network to support DSL service determined in step (e) includes at least one of the following:
a number useable DSL tones;
a number unusable DSL tones;
insertion loss;
signal-to-noise ratio per DSL tone;
bit-loading per DSL tone;
crest factor per DSL tone;
maximum data rate per DSL tone; and
maximum total data rate for all useable DSL tones.

16. A test device (30) for testing the capacity of a network comprised of one or more pairs of wires (6, 8, 8-1), an ATU-C modem (10) and an ATU-R modem (16) to support DSL service, the test device (30) comprising:
a controller (66);
a DC sampling circuit (54) operative under the control of the controller (66);
an AC sampling circuit (78) operative under the control of the controller (66);
a first connector (38) for coupling a pair of wires (8-1) to a first end of a pair of internal conductors (200, 202) of the test device (30);
a second connector (36) for coupling the ATU-R modem (16) to a second end of the pair of internal conductors (200, 202); and
means for connecting (57, 76) operative under the control of the controller (66) for selectively connecting the AC sampling circuit (78) to the first end of the pair of internal conductors (200, 202), to the second end of the pair of internal conductors (200, 202), or to both the first and second ends of the pair of internal conductors (200, 202).

17. The test device of claim 16, wherein the means for connecting includes:
a first relay (57) operative under the control of the controller (66) for selectively connecting and disconnecting the AC sampling circuit (78) to and from the first end of the pair of internal conductors (200, 202); and
a second relay (76) operative under the control of the controller (66) for selectively connecting and disconnecting the AC sampling circuit (78) to and from the second end of the pair of internal conductors (200, 202).

18. The test device of claim 16, further including a network analyzer (60) operative under the control of the controller (66), wherein, under the control of the controller (66) the means for connecting (57, 76) is operative for selectively connecting and disconnecting the network analyzer (60) to and from at least one of the following: the first end of the pair of internal conductors (200, 202), the second end of the pair of internal conductors (200, 202), or the both the first and second ends of the pair of internal conductors (200, 202) simultaneously.

19. The test device of claim 16, wherein one or more of the pairs (6, 8, 8-1) of wires are twisted pairs.
